(19) United States
(12) Patent Application Publication
(10) Pub. No.: US 2025/0138387 A1
(43) Pub. Date: May 1, 2025

(54) APPARATUS FOR USE IN FOUR WAVE MIXING AND METHOD FOR CONFIGURING A PHASE ADJUSTING MEANS THEREIN TO SUPPRESS UNWANTED IDLERS

(71) Applicant: University of Southampton, Southampton Hampshire (GB)

(72) Inventors: Periklis PETROPOULOS, Southampton Hampshire (GB); Kyle BOTTRILL, Southampton Hampshire (GB)

(73) Assignee: University of Southampton, Southampton Hampshire (GB)

(21) Appl. No.: 18/837,226

(22) PCT Filed: Feb. 10, 2023
(86) PCT No.: PCT/GB2023/050317

§ 371 Date: Aug. 9, 2024

(30) Foreign Application Priority Data
Feb. 11, 2022 (GB) 2201809.7

(51) Int. Cl. G02F 1/35; H04B 10/291

(52) U.S. Cl. CPC G02F 1/3536; H04B 10/291

(57) ABSTRACT

Apparatus for use in four wave mixing is disclosed, comprising a nonlinear medium for receiving a plurality of light beams copropagating along an optical path through the nonlinear medium, the plurality of light beams including at least one signal wave having a signal frequency and one or two pump waves having respective pump frequencies, the light beams generating one or more unwanted idler waves in the nonlinear medium. The apparatus further comprises phase adjusting means arranged to selectively apply to wavelengths of light in the nonlinear medium, respective wavelength-dependent phase shifts to adjust the phase difference between the or each pump wave and the signal wave, such that unwanted idler waves are generated along the optical path of the nonlinear medium so as to destructively interfere, suppressing unwanted idler waves at an output of the nonlinear medium. A method of configuring the phase adjusting means is disclosed.

### BACKGROUND

When radiation is incident upon a medium, the oscillating electromagnetic field interacts with electric dipoles in the molecules of the medium and causes them to oscillate. The result is a time-varying local electric polarisation in the medium. This oscillating electric field then re-radiates the electromagnetic field and the incident wave is considered to propagate through the medium via a series of such absorption and re-radiation processes. The polarisation vector, P, induced by an electric field with amplitude vector E can be expressed as a general series expansion of the form:

$$P = {ε}_{0} ( χ \cdot E + {χ}_{2} \cdot {E}^{2} + {χ}_{3} \cdot {E}^{3} + ⋯ )$$

where ε₀ is the electric permittivity of a vacuum, is the linear susceptibility tensor of the medium and χ₂ and χ₃ are second and third order susceptibility tensors terms.

If the induced polarisation has a purely linear dependence on the applied electric field then the re-radiated electric field will be identical to the incident field. However, when second or higher-order susceptibility terms are non-zero, such as in nonlinear medium, harmonics begin to appear in the radiated field that were not present in the incident field.

A nonlinear Kerr medium having a non-zero third order susceptibility term χ₃ (such as a highly nonlinear optical fibre formed of a silicate glass material having a high χ₃ value), gives rise to nonlinear behaviour of light propagating in the medium including self-phase modulation (SPM), cross phase modulation (CPM) and four wave mixing (FWM).

Four-wave mixing is a process in which optical waves at four frequencies interact via the non-linear response of the medium to the electric fields of the waves. Broadly speaking, four wave mixing (FWM) can elicit an interaction between any three waves copropagating in a Kerr medium to bring about the creation of a fourth. Assuming for simplicity that four optical waves incident upon a dielectric medium are linearly polarised parallel to the x-axis, the combined electric field can be expressed as:

$${E}_{TOT} = \hat{x} {\sum }_{j = 1}^{4} {E}_{j} cos ( {β}_{j} z - {ω}_{j} t )$$

where Eⱼ is the amplitude of the jth electric field and βⱼ is the propagation constant of the wave at frequency ωⱼ. The propagation constant is given by the relation:

$${β}_{j} = \frac{{n}_{j} ( ω ) {ω}_{j}}{c}$$

where nⱼ(ω) is the frequency-dependent refractive index and c is the speed of light in vacuum.

The second and third order expansion terms when equation for the combined electric field is substituted into the equation for the polarisation vector include a number of terms involving products of the four waves. By collecting terms at each of the four incident frequencies, the non-linear polarisation in the material, P_{NL} can be resolved into components at each frequency, j, such that:

$$P = {P}_{L} + {P}_{NL} = {P}_{L} + x {\sum }_{j = 1}^{4} {P}_{j} cos ( {β}_{j} z - {ω}_{j} t )$$

$$where$$

$${P}_{j} = \frac{3 {ε}_{0}}{4} {χ}_{3} [ {SPM}_{j} + {XPM}_{j} + {f}_{j} ( i {θ}_{+} ) + {g}_{j} ( i {θ}_{-} ) ]$$

and f and g are functions of the electric field amplitudes and also the parameters θ₊ and θ₋ discussed below.

The polarisation of the material at each of the incident frequencies can be seen from the equation for Pⱼ to include terms due to self-phase modulation, cross-phase modulation and two functions of the parameters θ₊ and θ₋ that represent the relative phase between the electric field and polarisation, P_{f} at the jth frequency. Four-wave mixing is most efficient when θ₊ or θ₋ approaches zero, where:

$${θ}_{+} = ( {β}_{1} + {β}_{2} + {β}_{3} - {β}_{4} ) z - ( {ω}_{1} + {ω}_{2} + {ω}_{3} - {ω}_{4} ) t$$

$$and$$

$${θ}_{-} = ( {β}_{1} + {β}_{2} + {β}_{3} - {β}_{4} ) z - ( {ω}_{1} + {ω}_{2} + {ω}_{3} - {ω}_{4} ) t$$

These two conditions give rise to different four-wave mixing phenomena. To minimise either θ₊ or θ₋ requires that certain conditions are satisfied by both the frequencies of the signals and their propagation constants. These conditions effectively amount to conservation of energy and momentum before and after the FWM interaction. The satisfaction of the latter condition is referred to as phase matching.

Phase matching of propagation constants for the θ₊ condition (i.e. β₁+β₂+β₃−β₄=0) is difficult to satisfy and in practice it is the second of the two FWM mechanisms (i.e. a) that is normally observed in nonlinear media.

Minimisation of θ₋ occurs when the frequencies of the waves satisfy the relation ω₁+ω₂=ω₃+ω₄ and the associated phase matching requirements are met (i.e. β₁+β₂−β₃−β₄=0). This can occur for the non-degenerate case, where ω₁≠ω₂≠ω₃≠ω₄ or the degenerate case, in which ω₁=ω₂≠ω₃≠ω₄. This FWM interaction is shown in FIG. 1, in which two input waves having frequencies ω₁ and ω₂ are combined with a third input wave having a frequency ω₃ to produce an output idler wave having frequency ω₄. FWM can occur for any combination of waves in the nonlinear medium for which the phase matching requirement are met. This interaction can be harnessed using, in the degenerate case a single pump wave (produced by a laser) such that the input waves are of the same frequency (i.e. ω₁=ω₂), or in the non-degenerate case where two pump waves are provided (produced by two lasers outputting different frequencies) such that the input waves are of different frequencies (i.e. ω₁≠ω₂), to interact with a signal wave to produce an idler wave at a different frequency based on the signal wave. In this way, FWM can in principle be exploited for the purposes of signal processing, for example in parametric amplification, wavelength/channel conversion, phase conjugation, optical sampling, nonlinear interaction of frequency comb lines or signal regeneration.

However, in addition to the wanted interactions between the pump or pump waves and the signal waves to produce wanted idler waves, FWM brings about a great variety of interactions with other wave combinations, leading to the generation of a great multitude of spurious signals which can ultimately lead to cross-talk between the channels being processed.

This is illustrated in FIG. 2 for the degenerate case, in which two pump waves having frequency ω₁ combine with a signal wave having frequency ω₂ to produce a wanted idler wave having frequency ω₁₁₂=2ω₁−ω₂, and in which one pump wave having frequency ω₁ combines with two signal waves having frequency ω₂ to produce an unwanted idler wave having frequency ω₂₂₁=2ω₂−ω₁. For the non-degenerate case where two pump wave sources having different frequencies are provided, the situation becomes even more complex, as illustrated in FIG. 3 in which the wanted idler waves produced based on some combination of two pump waves and one signal wave are indicated, and in which the unwanted idler waves based on some other combination of waves (for example one pump wave and two signal waves, or three pump waves), is shown. The number of combinations increases further when looking at higher order interactions, and where multiple signal waves with different frequencies are propagating through the nonlinear medium.

Steps taken to increase the efficiency of the generation of wanted idler signals, such as the use of increased launch powers into the nonlinear medium and improved phase matching, generally also benefit the generation of undesirable signals at the same time.

To mitigate the proliferation of unwanted idlers, in systems with distinct pumps and signals, the approach generally used in the art is to achieve a trade-off between the generation of wanted and unwanted idlers by maximizing pump power and restricting signal power, which restricts output idler optical signal to noise ratio (OSNR). Other suggested approaches have included the use of special dispersion engineering to isolate interacting systems, reserving bandwidth for unwanted idlers, or simply processing in multiple, isolated nonlinear media. These approaches and the presence of unwanted idlers as well as wanted idlers limit the usefulness of four wave mixing to be applied in signal processing for a variety of applications, which limits commercialisation of signal processing based on four wave mixing to convert signal wavelengths to multiplex fixed wavelength transmitters and mitigate channel contention, thereby increasing data throughput.

It is in this context that the present disclosure has been devised.

### SUMMARY OF THE DISCLOSURE

Viewed from one aspect, the present disclosure provides an apparatus for use in four wave mixing, comprising a nonlinear medium for receiving, in use, a plurality of light beams copropagating along an optical path through the nonlinear medium, the plurality of light beams including at least one signal wave having a signal frequency and one or two pump waves having respective pump frequencies, the nonlinear medium being such that three copropagating waves in the nonlinear medium having respective frequencies fⱼ, fₖ, fₗ generate by four wave mixing an idler wave having a frequency fᵢ according to the relation: fᵢ=fⱼ+fₖ−fₗ. In use, the light beams in the nonlinear medium generate one or more unwanted idler waves having respective frequencies f_{i.u1}, f_{i.u2} . . . f_{i.un} when only one of the waves providing one of the frequencies fⱼ, fₖ, fₗ in a four wave mixing interaction is provided by the or one of the pump waves, and the two other waves providing the other two of the frequencies fⱼ, fₖ, fₗ in the four wave mixing interaction are provided by waves other than a pump wave. The apparatus further comprises phase adjusting means arranged to selectively apply, at one or more locations within the optical path of the light beams through the nonlinear medium, to wavelengths of light in the nonlinear medium, respective wavelength-dependent phase shifts to adjust the phase difference between the or each pump wave and the signal wave, the wavelength-dependent phase shifts being such that unwanted idler waves are generated along the optical path of the nonlinear medium so as to destructively interfere, such that the unwanted idler waves are suppressed at an output of the nonlinear medium.

In accordance with the present disclosure, the apparatus for use in four wave mixing in accordance with this aspect enables suppression of unwanted idler waves at an output of a nonlinear medium by application of one or more wavelength-dependent phase shifts at locations throughout the nonlinear medium selected such that unwanted idler waves are generated to destructively interfere with each other at the output such that the unwanted idler waves are suppressed. This suppression of unwanted idlers is achieved without needing to compromise the idler OSNR or the bandwidth, or by complex engineering of dispersion to isolate interacting systems. The suppression of unwanted idlers in accordance with the present disclosure is achieved with nothing more than the application of a simple phase filter to apply a wavelength-dependent phase shift to adjust the phase difference between the or each pump wave and the signal wave. As can be seen below, once the phase shift is determined, the phase filter can be provided by passive components, such as a chirped fibre Bragg grating, which allows high power operation and lends itself readily to commercial deployment in a variety of signal processing applications. As will be seen, this approach has been shown to achieve suppression of unwanted idlers by as much as 26 dB.

In embodiments, in use, the light beams in the nonlinear medium may generate one or more wanted idler waves having respective frequencies f_{i.w1}, f_{i.w2} . . . f_{i.wn} when two of the waves in a four wave mixing interaction providing two of the frequencies fⱼ, fₖ, fₗ are provided by one or both of the pump waves, and the other wave providing the other one of the frequencies fⱼ, fₖ, fₗ in the four wave mixing interaction is provided by the or one of the signal waves. The phase adjusting means may be such that the wavelength-dependent phase shifts selectively applied by the phase adjusting means are such that wanted idler waves are generated along the optical path of the nonlinear medium so as to constructively interfere, such that the wanted idler waves are enhanced at the output of the nonlinear medium. In embodiments, the phase adjusting means may be such that the wavelength-dependent phase shifts selectively applied by the phase adjusting means are such that ratio of the power of the wanted idler waves to the power of the unwanted idler waves at the output of the nonlinear medium is maximised. In embodiments, the unwanted idler waves may be maximally suppressed so as to be substantially deleted at the output of the nonlinear medium. Thus, in accordance with the present disclosure, not only are unwanted idlers suppressed, wanted idler waves can not only remain unaffected, but they can also be enhanced. In particular, in accordance with the present disclosure, the ratio of the power of wanted to unwanted idlers can be maximised.

In embodiments, the phase adjusting means may be such that the wavelength-dependent phase shifts selectively applied by the phase adjusting means are such that dispersion in the nonlinear medium is compensated for at least in the frequency range including the or each pump wave, the or each signal wave and the or each wanted idler waves. Due to dispersion in the nonlinear medium, the pump waves and signal waves, being at different wavelengths, undergo an unknown phase shift over the length of their optical path in the nonlinear medium. In accordance with the present disclosure, the phase filter is also used to find and compensate for this relative phase shift due to wavelength-dependent dispersion in the nonlinear medium, allowing the dispersion profile of the fibre to be compensated for and phase matching condition to be met, such that a further phase shift can then be applied such that the relative phase between the or each pump and the or each signal can than be altered to suppress the unwanted idlers. Thus the resulting phase filter corrects for dispersion and suppresses the idlers, giving the phase filter a complex, non-dispersion-like phase profile.

In embodiments, the phase adjusting means may be such that, at one or more of the or each locations at which a wavelength-dependent phase shift is applied to wavelengths of light in the nonlinear medium, a π radian phase shift is selected to be applied to the or each pump wave, or to the or each signal wave. In embodiments, the phase adjusting means may be such that matching unwanted idler waves are generated in antiphase at different along the optical path of the nonlinear medium so as to destructively interfere and suppress the amplitude of the unwanted idler waves output from the nonlinear medium. By applying π radian phase shifts to the pump waves or the signal waves (typically, to one or both pumps) at locations in the optical path in the nonlinear medium, unwanted idler waves are generated in antiphase, which, if matched with each other, can lead to an overall suppression of the unwanted idler waves at the output of the nonlinear medium by destructive interference. By applying a π radian phase shift between the pump waves and signal waves, the wanted idler waves, being generated by two pump waves and a signal wave, see a 2π radian phase shift at each phase filter, meaning that they remain unaffected by the phase filter and are not suppressed.

In embodiments, the phase adjusting means may be such that a single wavelength-dependent phase shift is selectively applied to wavelengths of light in the nonlinear medium at a mid point in the optical path of the nonlinear medium. In embodiments, the phase adjusting means may be such that a single π radian phase shift is selected to be applied to the or each pump wave at a mid point in the optical path of the nonlinear medium. In this way, by applying a single phase shift in the middle of the optical path of the nonlinear medium, unwanted idler waves can be suppressed by the application of a single phase filter at a single location in the optical path.

In embodiments, the nonlinear medium may be an optical fibre, optionally a highly nonlinear optical fibre. In embodiments, the apparatus may further comprise a single pump wave source or two non-degenerate pump wave sources arranged to provide the or each pump wave to propagate along the optical path in the nonlinear medium. In embodiments, the apparatus may further comprise one or more signal wave sources arranged to provide the or each signal wave to propagate along the optical path in the nonlinear medium. In embodiments, the apparatus may be configured as a wavelength converter in a communications network, configured to convert one or more communications channel signal waves to idler waves at different frequencies for multiplexing into a communications medium to mitigate channel contention in the communications medium. In this way, the apparatus of the present disclosure can be applied to a range of different fibre-based applications for signal processing, such as wavelength conversion of a plurality of signals from a fixed wavelength source to allow multiplexing avoiding signal contention, further increasing throughput of a fibre-based network.

In embodiments, the phase adjusting means may comprise at least one programmable optical filter. In embodiments, the programmable optical filter may comprise a grating and a spatial light modulator comprising an array of controllable elements individually programmable to apply a selected phase shift to light beams incident thereon, the grating being arranged to disperse the light beams copropagating in the nonlinear medium across the array of controllable elements. In embodiments, the array of controllable elements may be a matrix of reflective liquid crystal on silicon elements. Use of a programmable optical filter enables the wavelength-dependent phase shift needed to suppress unwanted idlers and to compensate for dispersion in the nonlinear medium to be discovered and applied to generate a complex filter profile.

In embodiments, the phase adjusting means may comprise only passive optical components. In embodiments, the phase adjusting means may comprise at least one complex chirped fibre Bragg grating configured to apply the selected wavelength-dependent phase shifts to at least some of the wavelengths of the light beams copropagating in the nonlinear medium in use. Once the complex filter profile needed to suppress unwanted idlers is known for the non-linear medium and the pump and source wave(s), for example by discovery using a programmable optical filter, the phase filter profile can be implemented in passive components, allowing the advantages to be provided in the field using relatively cheap, reliable components that can operate stably at high power.

In embodiments, the apparatus may further comprise one or more erbium-doped fibre amplifiers (EDFAs) arranged at locations in along the optical path to amplify one of more of the waves copropagating in the optical path, the or each erbium-doped fibre amplifier being configured to balance the amplitude of the unwanted idler waves generated along the optical path such that the amplitude of the unwanted idler waves at an output of the nonlinear medium is minimised. The use of EDFAs in this way helps the balancing of the interactions in the different sections of the nonlinear medium after application of the wavelength-dependent phase shift.

In embodiments, along the optical path, the nonlinear medium may be of a single type, or the nonlinear medium may be of different types in sections along the optical path. While the present disclosure envisages the application of the wavelength-dependent phase shift within a nonlinear medium of a single type, the use of a complex phase filter can suppress idlers generated in sections of different nonlinear media.

Viewed from another aspect, the present disclosure provides a method for configuring a phase adjusting means in an apparatus for use in four wave mixing in accordance with aspects of the present disclosure to suppress unwanted idlers at an output of a nonlinear medium. The method comprises: operating a single pump wave source or two non-degenerate pump wave sources to provide the or each pump wave to propagate along the optical path in the nonlinear medium; operating one or more signal wave sources to provide the or each signal wave to propagate along the optical path in the nonlinear medium; detecting, using a detector, the light beams at the output of the nonlinear medium and determining a signal representative of the detected power spectral density of the light beams; and determining a wavelength-dependent phase shift for wavelengths of light propagating in the nonlinear medium so as to suppress the detected power of the unwanted idler waves at the frequencies f_{i.u1}, f_{i.u2} . . . f_{i.un} at an output of the nonlinear medium. In embodiments, determining the wavelength-dependent phase shift may comprise: determining a wavelength-dependent phase shift such that dispersion in the nonlinear medium is compensated for at least in the range including the or each pump wave, the or each signal wave and the or each wanted idler waves. In embodiments, determining a wavelength-dependent phase shift such that dispersion in the nonlinear medium is compensated may comprise: sweeping a wavelength of one of the signal wave sources in the range; and determining, at wavelengths in the sweep, a wavelength-dependent phase shift for that swept wavelength to maximise the detected power of a wanted idler wave generated for the signal wave at that swept wavelength. In embodiments, determining the wavelength-dependent phase shift may further comprise: determining a wavelength-dependent phase shift for wavelengths of light for the or each pump wave such that the detected power of the unwanted idler waves at the frequencies f_{i.u1}, f_{i.u2} . . . f_{i.un} at an output of the nonlinear medium is minimised. In embodiments, determining the wavelength-dependent phase shift may further comprise: determining a wavelength-dependent phase shift for wavelengths of light propagating in the nonlinear medium so as to enhance the detected power of the wanted idler waves at the frequencies f_{i.w1}, f_{i.w2} . . . f_{i.wn} at an output of the nonlinear medium. In embodiments, the method may further comprise determining a wavelength-dependent phase shift for wavelengths of light propagating in the nonlinear medium so as to maximise the ratio of the detected power of the wanted idler waves to the detected power of the unwanted idler waves at the output of the nonlinear medium. In this way, the complex wavelength-dependent phase shift needed to suppress unwanted idlers and compensate for dispersion can be determined.

In embodiments, determining the wavelength-dependent phase shift may comprise: providing, as the phase adjusting means, at least one programmable optical filter; adjusting the applied phase shift at the or each programmable optical filter based on the detected power to determine the wavelength-dependent phase shift. In embodiments, the method may further comprise determining one or more phase masks for one or more fibre Bragg gratings to provide the determined wavelength-dependent phase shift in the optical path; fabricating the or each fibre Bragg grating using the or each determined phase mask; and providing the or each fabricated fibre Bragg grating at locations in the optical path in the nonlinear medium to provide the phase adjusting means. In this way, after using a programmable optical filter to discover the complex wavelength-dependent phase shift needed to suppress unwanted idlers and compensate for dispersion can be determined, a simple passive phase filter having a matching complex filter profile can be made and deployed for high power use in the field.

It will be appreciated from the foregoing disclosure and the following detailed description of the examples that certain features and implementations described as being optional in relation to any given aspect of the disclosure set out above should be understood by the reader as being disclosed also in combination with the other aspects of the present disclosure, where applicable. Similarly, it will be appreciated that any attendant advantages described in relation to any given aspect of the disclosure set out above should be understood by the reader as being disclosed as advantages of the other aspects of the present disclosure, where applicable. That is, the description of optional features and advantages in relation to a specific aspect of the disclosure above is not limiting, and it should be understood that the disclosures of these optional features and advantages are intended to relate to all aspects of the disclosure in combination, where such combination is applicable.

### BRIEF DESCRIPTION OF THE DRAWINGS

Certain examples of the present disclosure will now be described with reference to the accompanying drawings, in which:

FIG. 1 illustrates a relation between the energies of the photons interacting as the pump and signal waves combine in four wave mixing;

FIG. 2 illustrates on a power spectrum against frequency an example of the generation of wanted and unwanted idler waves for an input pump wave and signal wave in the degenerate case;

FIG. 3 illustrates on a power spectrum against frequency an example of the generation of wanted and unwanted idler waves for an two input pump wave and an input signal wave in the non-degenerate case;

FIG. 4 illustrates an example apparatus for use in degenerate four wave mixing in accordance with aspects of the present disclosure;

FIG. 5 illustrates another example apparatus for use in degenerate and non-degenerate four wave mixing in accordance with aspects of the present disclosure, together with, on a power spectrum against frequency, the generation of wanted and unwanted idler waves and the suppression of unwanted idler waves at different locations in the optical path of the apparatus;

FIG. 6 illustrates a method for configuring a phase adjusting means in an apparatus as shown in FIGS. 4 and 5 to suppress unwanted idlers at an output of the nonlinear medium in accordance with aspects of the present disclosure; and

FIG. 7 illustrates an output power spectral density of an apparatus as shown in FIGS. 4 and 5 in the non-degenerate and degenerate cases with three signal waves at different frequencies as the programmable optical filter adjusts for dispersion and to suppress unwanted idlers.

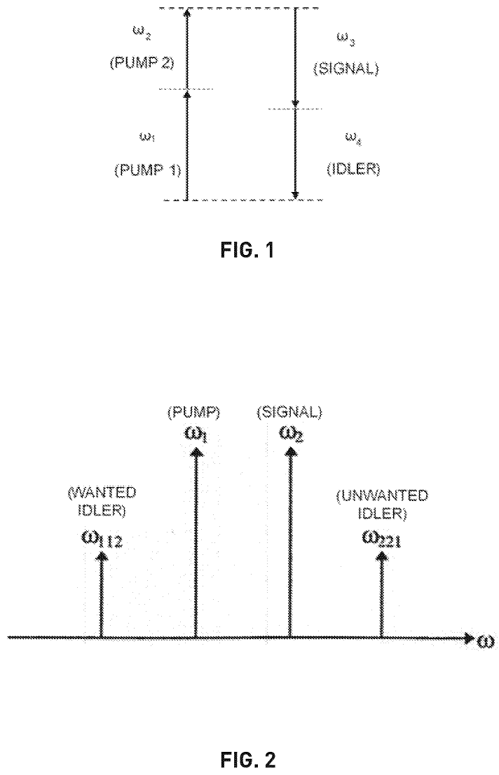

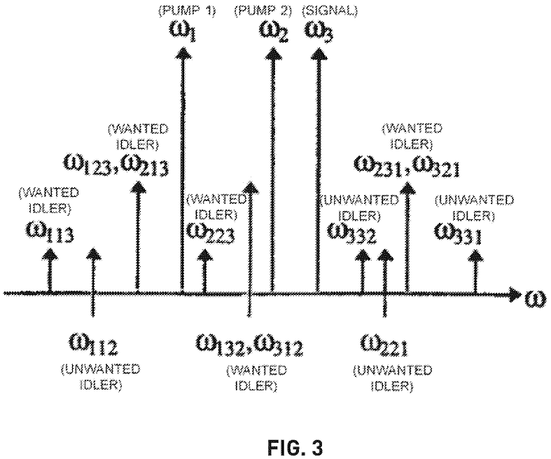

### DETAILED DESCRIPTION

Hereinafter, embodiments of the disclosure are described with reference to the accompanying drawings. However, it should be appreciated that the disclosure is not limited to the embodiments, and all changes and/or equivalents or replacements thereto also belong to the scope of the disclosure. The same or similar reference denotations may be used to refer to the same or similar elements throughout the specification and the drawings.

As used herein, the terms “have,” “may have,” “include,” or “may include” a feature (e.g., a number, function, operation, or a component such as a part) indicate the existence of the feature and do not exclude the existence of other features. Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

As used herein, the terms “A or B,” “at least one of A and/or B,” or “one or more of A and/or B” may include all possible combinations of A and B. For example, “A or B,” “at least one of A and B,” “at least one of A or B” may indicate all of (1) including at least one A, (2) including at least one B, or (3) including at least one A and at least one B.

As used herein, the terms “first” and “second” may modify various components regardless of importance and do not limit the components. These terms are only used to distinguish one component from another. For example, reference to a first component and a second component may indicate different components from each other regardless of the order or importance of the components.

It will be understood that when an element (e.g., a first element) is referred to as being (physically, operatively or communicatively) “coupled with/to,” or “connected with/to” another element (e.g., a second element), it can be coupled or connected with/to the other element directly or via a third element. In contrast, it will be understood that when an element (e.g., a first element) is referred to as being “directly coupled with/to” or “directly connected with/to” another element (e.g., a second element), no other element (e.g., a third element) intervenes between the element and the other element.

The terms as used herein are provided merely to describe some embodiments thereof, but not to limit the scope of other embodiments of the disclosure. It is to be understood that the singular forms “a,” “′an,” and “the” include plural references unless the context clearly dictates otherwise. All terms including technical and scientific terms used herein have the same meaning as commonly understood by one of ordinary skill in the art to which the embodiments of the disclosure belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

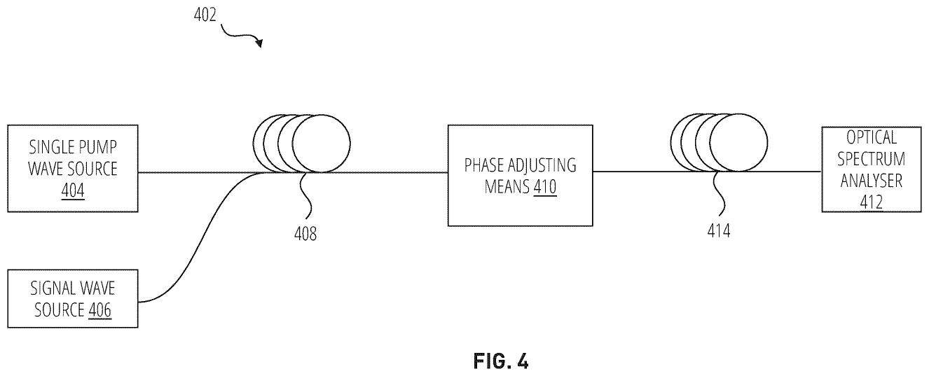

Reference will now be made to FIG. 4, which illustrates an example apparatus 402 for use in degenerate four wave mixing in accordance with aspects of the present disclosure. The apparatus 402 comprises a highly nonlinear optical fibre 408, a phase adjusting means 410 and a highly nonlinear optical fibre 414.

The highly nonlinear optical fibre 408 and highly nonlinear optical fibre 414 together form a nonlinear medium for receiving, in use, a plurality of light beams copropagating along an optical path through the nonlinear medium. The highly nonlinear optical fibre 408 and highly nonlinear optical fibre 414 may be two equal lengths of optical fibre comprised of a material having a high third order susceptibility term χ₃ such that four wave mixing interactions occur between waves of light beams copropagating in the fibres.

For this purpose, a signal wave source 406 providing a source of one signal wave having a frequency fₛ, is arranged to provide a light beam to the highly nonlinear optical fibre 408. To create an idler wave in the nonlinear medium based on a signal wave, for example, for wavelength conversion, a single pump wave source 404 is arranged to provide a light beam having a phase matched pump wave to the highly nonlinear optical fibre 408 having a frequency f_{P}.

In the first length of highly nonlinear optical fibre 408, the signal wave and the pump wave combine to provide a wanted idler wave having a frequency of 2f_{P}−f_{S}. That is, the wanted idler wave is generated by four wave mixing when two of the waves in a four wave mixing interaction providing two of the input frequencies are provided by the pump wave (in the degenerate case).

Also, in the first length of highly nonlinear optical fibre 408, the signal wave and the pump wave combine to provide an unwanted idler wave having a frequency of 2f_{S}−f_{P}. That is, the unwanted idler wave is generated by four wave mixing when only one of the waves in a four wave mixing interaction providing one of the input frequencies is provided by the pump wave, and the two other waves providing the other two input frequencies fⱼ, fₖ, fₗ are provided by waves other than a pump wave (in this case, the signal wave combines twice, in a degenerate way, to produce the unwanted idler wave).

At a mid point in the nonlinear medium, between the first length of highly nonlinear optical fibre 408 and the second length of highly nonlinear optical fibre 414, the spectrum like that shown in FIG. 2 results (once dispersion is compensated for).

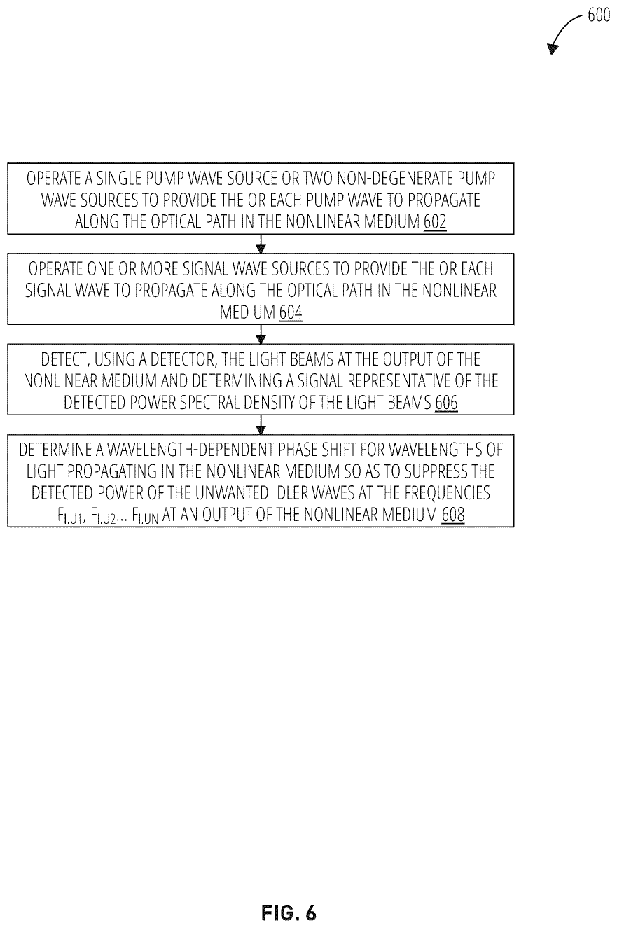

To suppress the unwanted idler wave, a phase adjusting means 410 is arranged at the mid point in the nonlinear medium to selectively apply, to wavelengths of light in the nonlinear medium, respective wavelength-dependent phase shifts by means of a complex phase filter. The phase adjusting means 410 may be provided by a programmable optical filter comprising a grating and a spatial light modulator comprising an array of controllable elements individually programmable to apply a selected phase shift to light beams incident thereon, the grating being arranged to disperse the light beams copropagating in the nonlinear medium across the array of controllable elements. The array of controllable elements may be a matrix of reflective liquid crystal on silicon elements. The complex filter profile needed to be applied by the phase adjusting means 410 may be discovered by operation of the programmable optical filter using the method described in relation to FIG. 6. Alternatively, the phase adjusting means 410 may be provided by only passive optical components, such as a complex chirped fibre Bragg grating coupled to between the first length of highly nonlinear optical fibre 408 and the second length of highly nonlinear optical fibre 414 by an optical circulator. The complex chirped fibre Bragg grating may be profiled to provide the same complex phase filter to the light beams in the nonlinear medium as that discovered by the programmable optical filter.

The phase adjusting means 410 is configured to apply selected wavelength-dependent phase shifts to at least some of the wavelengths of the light beams copropagating in the nonlinear medium in use to at least adjust the phase difference between the pump wave and the signal wave. In the embodiment, the phase adjusting means 410 is also configured to selectively apply wavelength-dependent phase shifts such that dispersion in the nonlinear medium (and in the connections in the optical path) is compensated for at least in the frequency range including the pump wave, the or each signal wave and the or each wanted idler wave and unwanted idler wave. In addition to dispersion being compensated for, the phase adjusting means 410 is configured to apply a π radian phase shift to the pump wave such that the relative phase shift between the pump wave and the signal wave is π radians. In other embodiments, the relative phase shift between the pump wave and the signal wave may be achieved by applying the π radian phase shift to the frequency of the signal wave.

The light beams, having had the selected wavelength-dependent phase shifts applied, are passed from the phase adjusting means 410 to the second length highly nonlinear optical fibre 414, in which the pump wave and the signal wave combine by four wave mixing to produce a further wanted idler wave and a further unwanted idler wave, matching in power the wanted idler wave and unwanted idler wave generated by four wave mixing in the first length of highly nonlinear optical fibre 408.

However, at the output of the nonlinear medium, at the end of the second length of highly nonlinear optical fibre 414, the optical spectrum analyser 412 reveals that the wanted idler wave is present in the spectrum, unaffected by the wavelength-dependent phase shifts, but the unwanted idler wave has been deleted. As momentum—and thus phase—is conserved in four wave mixing interactions, by applying π radian phase shift to the pump waves at the mid point in the optical path in the nonlinear medium using the phase adjusting means 410, the unwanted idler waves generated in the first length of highly nonlinear optical fibre 408 and the second length of highly nonlinear optical fibre 414 are in antiphase. Thus, these unwanted idler waves destructively interfere with each other and, as they are matched with each other in power, can lead to an overall suppression of the unwanted idler waves at the output of the nonlinear medium. By applying a π radian phase shift between the pump waves and signal waves, the wanted idler waves, being generated by two pump waves and a signal wave, see a 2π radian phase shift at each phase filter, meaning that the wanted idler waves generated in the first length of highly nonlinear optical fibre 408 and the second length of highly nonlinear optical fibre 414 are in phase and remain unaffected by the phase filter and are not suppressed.

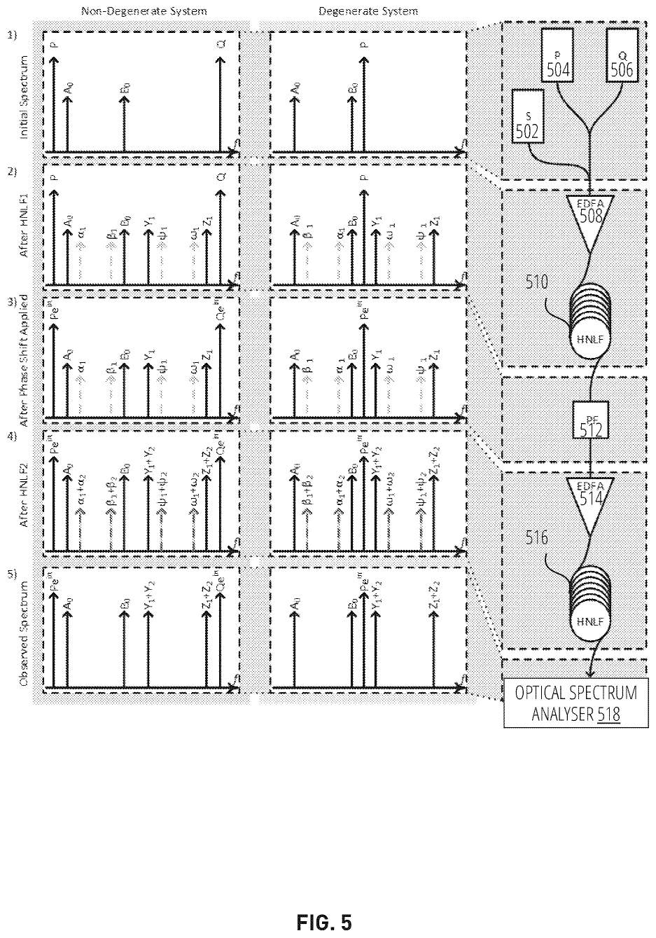

Reference will now be made to FIG. 5, which illustrates in more detail another example apparatus 500 for use in degenerate and non-degenerate four wave mixing in accordance with aspects of the present disclosure. Unlike the FIG. 4 embodiment, the apparatus of FIG. 5 comprises a signal wave source 502 (indicated by ‘S’ in FIG. 5) that provides two input signals for wavelength conversion, including a first signal wave having a frequency f_{A0} and a second signal wave having a frequency f_{B0}. The apparatus also includes a first pump wave source 504 (indicated by ‘P’ in FIG. 5) that provides a phase matched pump wave frequency f_{P}, and a second pump wave source 506 (indicated by ‘Q’ in FIG. 5) that provides a phase matched pump wave frequency f_{Q}. The second pump wave source 506 can optionally be operated in addition to the first pump wave source 504 so that the apparatus is operating with two the non-degenerate pump wave sources. As can be seen in the left and central panels of FIG. 5, the illustrative initial spectrum provided by the signal wave source 502 and the first pump wave source 504 and second pump wave source 506 to the highly nonlinear optical fibre 510 is shown in the top pane (identified by the number 1), on the left for the non-degenerate operation mode, and in the centre for the degenerate operation mode. Here, the signal waves are indicated at their respective frequencies as A₀ and B₀ and the pumps are indicated as P and Q.

Before being passed into the highly nonlinear optical fibre 510, the input light beams can be amplified using an erbium-doped fibre amplifier 508. After having passed through the first length of highly nonlinear optical fibre 510, the pump waves and signal waves have undergone a first stage of four wave mixing.

The results of this initial stage of FWM are illustrated in the second pane in FIG. 5 (identified by the number 1), on the left for the non-degenerate operation mode, and in the centre for the degenerate operation mode. Referring to the non-degenerate process, it can be seen that the desired, non-degenerate FWM process, in which signals A₀ and B₀ have been converted to wanted idlers Y₁ and Z₁ (having respective frequencies f_{Y1} and f_{Z1}), has accompanied by a number of undesired processes which have created unwanted idlers α₁, β₁, ψ₁ and ω₁ (having respective frequencies f_{α1}, f_{β1}, f_{ψ1} and f_{ω1}). The phases, ϕ, of these six waves can be determined using the normal rules for FWM (based on the conservation of momentum) and are as follows:

$${ϕ}_{z 1} = {ϕ}_{P} + {ϕ}_{Q} - {ϕ}_{{A}_{0}} \qquad ( 1 )$$

$${ϕ}_{Y 1} = {ϕ}_{P} + {ϕ}_{Q} - {ϕ}_{{E}_{0}} \qquad ( 2 )$$

$${ϕ}_{{α}_{1}} = 2 {ϕ}_{{A}_{0}} - {ϕ}_{P} \qquad ( 3 )$$

$${ϕ}_{{β}_{1}} = {ϕ}_{P} + {ϕ}_{{B}_{0}} - {ϕ}_{{A}_{0}} \qquad ( 4 )$$

$${ϕ}_{{ω}_{1}} = 2 {ϕ}_{{Z}_{1}} - {ϕ}_{Q} \qquad ( 5 )$$

$${ϕ}_{{ψ}_{1}} = {ϕ}_{Q} + {ϕ}_{{Y}_{1}} - {ϕ}_{{Z}_{1}} \qquad ( 6 )$$

After this first stage of FWM has taken place in highly nonlinear optical fibre 510, a wavelength-dependent phase shift is applied by a complex phase filter in the form of programmable optical filter 512. The programmable optical filter 512 if configured to apply a phase shift of π to each of the pumps P and Q (or indeed +π to one pump and −π to the other), although the complex filter can also be used to compensate for dispersion within the nonlinear media as well as compensating for dispersion arising in the connections between the two lengths of highly nonlinear optical fibre, for example in patch cords in the optical path. The illustrative power spectrum shown in the third pane of FIG. 5, after the application of the complex phase filter, shows that, as this is simply a phase filter, there is no change in the power spectrum compared to the output in the second pane after the first stage of FWM.

Before being passed into the highly nonlinear optical fibre 516, the light beams output from programmable optical filter 512 can be amplified using an erbium-doped fibre amplifier 514 such that the power of the generated idlers in the second stage of four wave mixing in the second length of highly nonlinear optical fibre 516 match the power of the idlers generated in the first stage. The use of EDFAs in this way helps the balancing of the interactions in the different sections of the nonlinear medium after application of the wavelength-dependent phase shift.

In the second stage of FWM, idlers are created which, naturally, coherently add to the idlers generated in the first stage, as illustrated in the power spectrum shown in the fourth pane. The phases of the idlers generated in the second stage are as follows:

$${ϕ}_{{Z}_{2}} = ( {ϕ}_{P} + π ) + ( {ϕ}_{Q} + π ) - {ϕ}_{{A}_{0}} = {ϕ}_{{Z}_{1}} \qquad ( 7 )$$

$${ϕ}_{{Y}_{2}} = ( {ϕ}_{P} + π ) + ( {ϕ}_{Q} + π ) - {ϕ}_{{E}_{0}} = {ϕ}_{{Y}_{1}} \qquad ( 8 )$$

$${ϕ}_{{α}_{2}} = 2 {ϕ}_{{A}_{0}} - ( {ϕ}_{P} + π ) = {ϕ}_{{a}_{1}} + π \qquad ( 9 )$$

$${ϕ}_{{β}_{2}} = ( {ϕ}_{P} + π ) + {ϕ}_{{B}_{0}} - {ϕ}_{{A}_{0}} = {ϕ}_{{β}_{1}} + π \qquad ( 10 )$$

$${ϕ}_{{ω}_{2}} = 2 {ϕ}_{Z ,} - ( {ϕ}_{Q} + π ) = {ϕ}_{ω ,} + π \qquad ( 11 )$$

$${ϕ}_{{ψ}_{2}} = ( {ϕ}_{Q} + π ) + {ϕ}_{{Y}_{1}} - {ϕ}_{{Z}_{1}} = {ϕ}_{{ψ}_{1}} + π \qquad ( 12 )$$

Looking at, for instance, equations (2) and (7) above, for the phase of the wanted idlers Z₂ and Y₂ generated in the second stage of FWM, we can see that, because both pumps possess a π phase shift, these sum to equal 2π, which of course is equivalent to a no phase shift at all, and ϕ_{Y1} and ϕ_{Y2} are equal and in phase, and the same is the case for ϕ_{Z1} and ϕ_{Z2}. Hence, the wanted idlers Z₁ and Z₂ of the signal A and the wanted idlers Y₁ and Y₂ of the signal B, generated in both the first length of highly nonlinear optical fibre 510 and the second length of highly nonlinear optical fibre 516 interfere constructively, as if no phase shift was applied at all. As such, the wanted idler waves are enhanced at the output of the nonlinear medium.

In contrast, as equations (9)-(12) above show, application of the π phase shift to the pumps results in the unwanted idlers generated in the second stage having a π phase shift relative to those unwanted idlers generated in the first stage (i.e. compare to equations. (3)-(6)). For example, the phase ϕₐ₂ of the unwanted idler α₂ generated in the second stage of FWM is shifted by π radians relative to the phase ϕₐ₁ the unwanted idler α₂ generated in the first stage of FWM. As such, these unwanted idlers will interfere destructively are eliminated at the output of the second length of highly nonlinear optical fibre 516, as measured at optical spectrum analyser 518 and as shown in the bottom pane in FIG. 5. Thus, with the programmable optical filter 512 configured in accordance with the present disclosure, the selectively applied wavelength-dependent phase shifts are such that the unwanted idler waves can be maximally suppressed so as to be substantially deleted at the output of the nonlinear medium.

The scheme functions just as well for degenerate (single-pump) systems. The middle column of FIG. 5 illustrates the steps discussed above for such a degenerate system. Mathematically, the results above can be translated to those of the degenerate system, simply by replacing with ϕ_{Q}, with ϕ_{P}, the conclusions remaining unchanged.

As can be seen, the wavelength-dependent phase shifts selectively applied by the programmable optical filter 512 are such that ratio of the power of the wanted idler waves to the power of the unwanted idler waves at the output of the nonlinear medium is maximised.

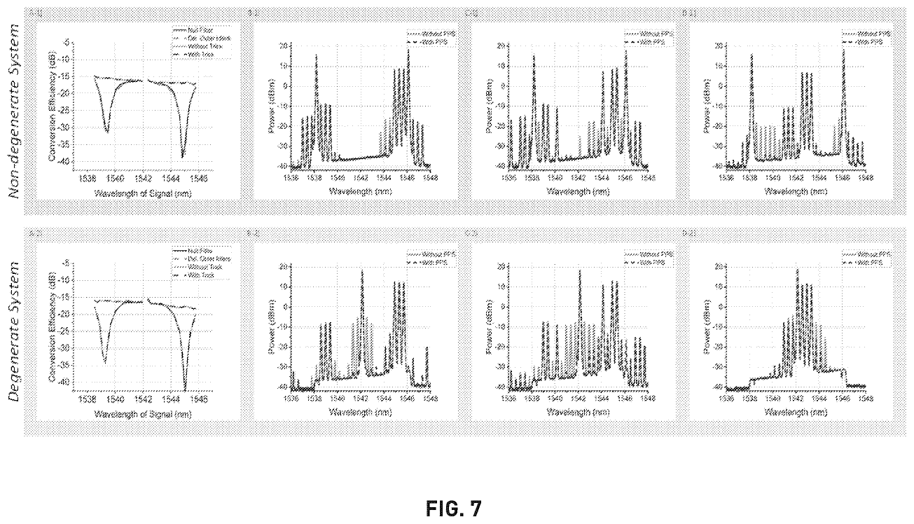

The method for configuring the programmable optical filter 512 to provide the phase adjusting means to suppress unwanted idlers at an output of the nonlinear medium will now be described with reference to FIG. 6, and specifically in relation to an experimental configuration of the phase adjusting means of the apparatus shown in FIG. 5, the results of which are shown in FIG. 7

In block 602, a single pump wave source or two non-degenerate pump wave sources are operated to provide the or each pump wave to propagate along the optical path in the nonlinear medium. In block 604, routine 600 operates one or more signal wave sources to provide the or each signal wave to propagate along the optical path in the nonlinear medium. In the experiment based on FIG. 5, three CW lasers were multiplexed using two polarization maintaining fused couplers, to ensure they are all copolarised. For the degenerate study, the second pump wave source 506 laser ‘Q’ was deactivated. The signals were then amplified using erbium-doped fibre amplifier 508 to a before they are passed into the first length of highly nonlinear optical fibre 510. Thereafter, the light beams are passed to a programmable optical filter 512 for applying a wavelength-dependent phase shift, after which the phase shifted light beams are all amplified in a second erbium-doped fibre amplifier 514, before being passed through the second length of highly nonlinear optical fibre 516 to undergo the second stage of FWM.

To allow the programmable optical filter 512 to be controlled to determine the wavelength-dependent phase shifts, in block 606, the light beams are detected, using a detector at the output of the nonlinear medium, and a signal representative of the detected power spectral density of the light beams is determined.

Where dispersion compensation is used, in order to simplify the bandwidth over which dispersion compensation is performed, the programmable optical filter 512 is also used to block all idlers generated outside of the two pumps, although this is not a requirement. A wavelength-dependent phase shift may also be determined such that dispersion in the nonlinear medium is compensated for (at least in the range including the or each pump wave, the or each signal wave and the or each wanted idler waves). This may comprise: sweeping a wavelength of one of the signal wave sources, and determining, at wavelengths in the sweep, a wavelength-dependent phase shift for that swept wavelength to maximise the detected power of a wanted idler wave generated for the signal wave.

In block 608, with reference to the power spectrum detected at the output of the second highly nonlinear optical fibre 516, a wavelength-dependent phase shift is determined for wavelengths of light propagating in the nonlinear medium so as to suppress the detected power of the unwanted idler waves at the frequencies f_{i.u1}, f_{i.u2} . . . f_{i.un} at an output of the nonlinear medium. The wavelength-dependent phase shift may be such that the detected power of the unwanted idler waves is minimised, the detected power of the wanted idler waves is enhanced, or the ratio of the detected power of the wanted idler waves to the detected power of the unwanted idler waves may be maximised. In this respect, the programmable optical filter 512 is adjusted to minimise unwanted idler generation, by applying an appropriate π radian phase shift to the wavelengths of the or each pump wave. This π radian phase shift is applied in addition to compensating for the dispersion of both the highly nonlinear optical fibres and the optical path between them.

To balance unwanted idler generation between the two stages, the power of second erbium-doped fibre amplifier 514 was tuned until unwanted idler generation was minimized by the unwanted idler waves generated in antiphase in the two sections of highly nonlinear optical fibres being matched in amplitude.

Once the complex profile phase filter needed to suppress unwanted idlers and compensate for dispersion has been determined, the bulky and expensive programmable optical filter 512 may be replaced by one or more smaller, cheaper passive optical components, which lend themselves to deployment in the field. As long as the pump waves remain of constant wavelength, the phase filter profile needed to compensate for dispersion and suppress unwanted idlers should remain settled, and so embedding this phase profile in an appropriately configured passive optical component can provide stable idler suppression in a four wave mixing system for field deployment. This implementation in passive optical components may be achieved by determining one or more phase masks for one or more fibre Bragg gratings to provide the determined wavelength-dependent phase shift in the optical path. Any appropriate algorithm for grating design may be used, for example including the efficient inverse scattering algortith proposed by Feced et al in their paper “An efficient inverse scattering algorithm for the design of nonuniform fiber Bragg gratings” published in the IEEE Journal of Quantum Electronics, Volume: 35, Issue: 8, August 1999. Once an appropriate phase mask or photo mask is determined to produce the fibre Bragg grating with the desired wavelength-dependent phase shift filter profile, the (or each) fibre Bragg grating is then fabricated using the or each determined phase mask. The programmable optical filter 512 is then removed and replaced with the or each fabricated fibre Bragg grating to provide the phase adjusting means.

The power spectra showing the observed experimental output of the nonlinear medium as the programmable optical filter 512 is adjusted to compensate for dispersion and suppress unwanted idlers. is shown in FIG. 7. The results the non-degenerate and a degenerate pump system are provided in FIG. 7 on the top and bottom row, respectively. Given the similarity of the results, it is efficient to discuss them for both systems at the same time.

Firstly, a single signal was launched from signal wave source 502 into the nonlinear medium, and its wavelength was swept between the two wavelengths of the first pump wave source 504 and second pump wave source 506 whilst and the conversion efficiency of desired idler generation measured using optical spectrum analyser 518.

This measurement was repeated for four different scenarios: 1) with a null filter profile; 2) with idlers lying outside of the pump wavelengths deleted (but with no phase shifts applied); 3) with dispersion compensation and outer idler deletion (but no phase shift applied to the pumps); and 4) with dispersion compensation, outer idler deletion and pump phase shifts applied.

Referring to the first pane, on the left of FIG. 7, deletion of the outer idlers can be seen to have very little effect upon conversion efficiency when compared to the null filter case and this comparison is provided to assure readers that no unforeseen effects occurred from idler deletion. In both cases, low power troughs can be seen, owing to the interaction between dispersion and phase matching in FWM (with the majority of the dispersion arising from the patchcords between the highly nonlinear optical fibres). In the first pane on the left of FIG. 7 (indicated by A−1 and A−2), application of dispersion correction can be seen to raise the conversion efficiency to a reasonably flat −15 to −17 dB and −16 dB to −18 dB, in the non-degenerate and degenerate cases, respectively.

Next, two additional signals were multiplexed alongside the original signal, giving three signals in total in the nonlinear medium, to test performance in a multi-channel setting. The three signals were arranged (in wavelength) in three different scenarios: scenario 1 (shown in FIG. 7 in the second pane indicated by B−1 and B−2), scenario 2 (shown in FIG. 7 in the third pane indicated by C−1 and C−2) and scenario 3 (shown in FIG. 7 in the third pane indicated by D−1 and D−2), to explore a range of interactions. In both the degenerate and non-degenerate cases, it was possible to test the exact same scenarios, as the centre of spectral inversion was the same. Firstly, considering the solid lines (marked in the legend as “Without PPS” (i.e. Programmed Phase Shift)) showing the output of the system without the π phase shift applied, the diversity of interactions expressed by FWM can easily be seen, and they are particularly noticeable in scenario 2, wherein the power ratio between many of the spurious idlers to the desired idlers can be as little as −10 dB in the non-degenerate system and +2 dB in the degenerate system, indicating the potential for severe cross-talk.

The dashed line (marked in the legend as “With PPS” (i.e. Programmed Phase Shift)) shows the results after applying the ˜ radian pump phase shifts to the wavelength of the pumps. In this case, the unwanted idlers can be seen to be almost completely suppressed, in that the unwanted idler peaks shown in the grey, unbroken lines, are absent in the dashed lines, in many cases lying beneath the ASE noise floor. Considering scenario 2 as an example (shown in the third pane indicated by C−1 and C−2) unwanted idler suppression can be seen as large as 18 dB in the non-degenerate system and 26 dB in the degenerate system. Overall, these results indicate that the technique disclosed herein effectively cures unwanted idler induced cross-talk in these systems.

We have proposed and demonstrated a technique to suppress spurious idler generation in FWM based optical processing systems. Spurious idler generation is often a limiting factor to performance, forcing system designers to compromise on processing bandwidth or output power and SNR. By separating the nonlinear processing media into two halves and applying π radian phase shift to the pumps at the mid-point, spurious FWM in the second half can be used to negate that of the first half. Suppression of spurious idler generation was seen to be as large as 18 dB in the non-degenerate system tested and 26 dB in the degenerate system, in both cases being reduced to the ASE level. We believe this technique offers a practical and effective solution to suppressing spurious idler generation that will prove to be compatible with many FWM-based processing schemes.

Although, in the embodiments described in relation to FIG. 4 and FIG. 5, the nonlinear medium is a highly nonlinear optical fibre, a phase adjusting means can be used at locations in any suitable nonlinear medium to suppress unwanted idlers generated by four wave mixing.

Although, in the embodiments described in relation to FIG. 4 and FIG. 5, along the optical path, the nonlinear medium is of a single type, in other embodiments the nonlinear medium may be of different types in sections along the optical path. While the present disclosure envisages the application of the wavelength-dependent phase shift within a nonlinear medium of a single type, the use of a complex phase filter can suppress idlers generated in sections of different nonlinear media.

Although, in the embodiments described in relation to FIG. 4 and FIG. 5, the phase adjusting means is such that a single π radian wavelength-dependent phase shift is selected to be applied to the to wavelengths of light for the or each pump wave in the nonlinear medium at a mid point in the optical path of the nonlinear medium, other arrangements are possible. For example, the phase adjusting means may be such that, a wavelength-dependent phase shift may be applied at plural locations in the optical path within the nonlinear medium, for example by applying at each location a π radian phase shift to the or each pump wave, or to the or each signal wave. In this way, the phase adjusting means may be such that matching unwanted idler waves are generated in antiphase at different along the optical path of the nonlinear medium so as to destructively interfere and suppress the amplitude of the unwanted idler waves output from the nonlinear medium.

Although for simplicity, the equations above and the embodiments set out the operation of four wave mixing with copropagating co-polarised light, this is not a requirement and the apparatus and method can be applied to suppress unwanted idlers occurring where the copropagating waves are not all co-polarised.

In accordance with the present disclosure, the apparatus for use in four wave mixing in accordance with this aspect enables suppression of unwanted idler waves at an output of a nonlinear medium by application of one or more wavelength-dependent phase shifts at locations throughout the nonlinear medium selected such that unwanted idler waves are generated to destructively interfere with each other at the output such that the unwanted idler waves are suppressed. This suppression of unwanted idlers is achieved without needing to compromise the idler OSNR or the bandwidth, or by complex engineering of dispersion to isolate interacting systems. The suppression of unwanted idlers in accordance with the present disclosure is achieved with nothing more than the application of a simple phase filter to apply a wavelength-dependent phase shift to adjust the phase difference between the or each pump wave and the signal wave. As can be seen below, once the phase shift is determined, the phase filter can be provided by passive components, such as a chirped fibre Bragg grating, which allows high power operation and lends itself readily to commercial deployment in a variety of signal processing applications. As will be seen, this approach has been shown to achieve suppression of unwanted idlers by as much as 26 dB.

In accordance with the present disclosure, not only can unwanted idlers be suppressed, wanted idler waves can not only remain unaffected, but they can also be enhanced. In particular, in accordance with the present disclosure, the ratio of the power of wanted to unwanted idlers can be maximised.

In accordance with the present disclosure, unwanted idler waves can be suppressed by the application of a single phase filter at a single location in the optical path.

In accordance with the present disclosure, the apparatus of the present disclosure can be applied to a range of different fibre-based applications for signal processing, such as wavelength conversion of a plurality of signals from a fixed wavelength source to allow multiplexing avoiding signal contention, further increasing throughput of a fibre-based network.

Features, integers, characteristics described in conjunction with a particular aspect, embodiment or example of the disclosure are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The disclosure is not restricted to the details of any foregoing embodiments. The disclosure extends to any novel one, or any novel combination, of the features disclosed in this specification (including any accompanying claims, abstract and drawings), or to any novel one, or any novel combination, of the steps of any method or process so disclosed. In particular, any dependent claims may be combined with any of the independent claims and any of the other dependent claims.

1. Apparatus for use in four wave mixing, comprising
a nonlinear medium for receiving, in use, a plurality of light beams copropagating along an optical path through the nonlinear medium, the plurality of light beams including at least one signal wave having a signal frequency and one or two pump waves having respective pump frequencies, the nonlinear medium being such that three copropagating waves in the nonlinear medium having respective frequencies fⱼ, fₖ, fₗ generate by four wave mixing an idler wave having a frequency fⱼ according to the relation: fᵢ=fⱼ+fₖ−fₗ;
wherein, in use, the light beams in the nonlinear medium generate one or more unwanted idler waves having respective frequencies f_{i.u1}, f_{i.u2} . . . f_{i.un} when only one of the waves providing one of the frequencies fⱼ, fₖ, fₗ in a four wave mixing interaction is provided by the or one of the pump waves, and the two other waves providing the other two of the frequencies fⱼ, fₖ, fₗ in the four wave mixing interaction are provided by waves other than a pump wave;
the apparatus further comprising:
phase adjusting means arranged to selectively apply, at one or more locations within the optical path of the light beams through the nonlinear medium, to wavelengths of light in the nonlinear medium, respective wavelength-dependent phase shifts to adjust the phase difference between the or each pump wave and the signal wave, the wavelength-dependent phase shifts being such that unwanted idler waves are generated along the optical path of the nonlinear medium so as to destructively interfere, such that the unwanted idler waves are suppressed at an output of the nonlinear medium.

2. The apparatus of claim 1, wherein, in use, the light beams in the nonlinear medium generate one or more wanted idler waves having respective frequencies f_{i.w1}, f_{i.w2} . . . f_{i.wn} when two of the waves in a four wave mixing interaction providing two of the frequencies fⱼ, fₖ, fₗ are provided by one or both of the pump waves, and the other wave providing the other one of the frequencies fⱼ, fₖ, fₗ in the four wave mixing interaction is provided by the or one of the signal waves;
wherein the phase adjusting means is such that the wavelength-dependent phase shifts selectively applied by the phase adjusting means are such that wanted idler waves are generated along the optical path of the nonlinear medium so as to constructively interfere, such that the wanted idler waves are enhanced at the output of the nonlinear medium.

3. The apparatus of claim 2, wherein the phase adjusting means is such that the wavelength-dependent phase shifts selectively applied by the phase adjusting means are such that ratio of the power of the wanted idler waves to the power of the unwanted idler waves at the output of the nonlinear medium is maximised.

4. The apparatus of claim 1, wherein the unwanted idler waves are maximally suppressed so as to be substantially deleted at the output of the nonlinear medium.

5. The apparatus of claim 1, wherein the phase adjusting means is such that the wavelength-dependent phase shifts selectively applied by the phase adjusting means are such that dispersion in the nonlinear medium is compensated for at least in the frequency range including the or each pump wave, the or each signal wave and the or each wanted idler waves.

6. The apparatus of claim 1, wherein the phase adjusting means is such that, at one or more of the or each locations at which a wavelength-dependent phase shift is applied to wavelengths of light in the nonlinear medium, a π radian phase shift is selected to be applied to the or each pump wave, or to the or each signal wave.

7. The apparatus of claim 1, wherein the phase adjusting means is such that matching unwanted idler waves are generated in antiphase at different along the optical path of the nonlinear medium so as to destructively interfere and suppress the amplitude of the unwanted idler waves output from the nonlinear medium.

8. The apparatus of claim 1, wherein the phase adjusting means is such that a single wavelength-dependent phase shift is selectively applied to wavelengths of light in the nonlinear medium at a mid point in the optical path of the nonlinear medium.

9. The apparatus of claim 1, wherein the phase adjusting means is such that a single π radian phase shift is selected to be applied to the or each pump wave at a mid point in the optical path of the nonlinear medium.

10. (canceled)

11. (canceled)

12. (canceled)

13. (canceled)

14. The apparatus of claim 1, wherein the phase adjusting means comprise at least one programmable optical filter comprising a grating and a spatial light modulator comprising an array of controllable elements individually programmable to apply a selected phase shift to light beams incident thereon, the grating being arranged to disperse the light beams copropagating in the nonlinear medium across the array of controllable elements.

15. (canceled)

16. (canceled)

17. (canceled)

18. The apparatus of claim 1, further comprising one or more erbium-doped fibre amplifiers arranged at locations in along the optical path to amplify one of more of the waves copropagating in the optical path, the or each erbium-doped fibre amplifier being configured to balance the amplitude of the unwanted idler waves generated along the optical path such that the amplitude of the unwanted idler waves at an output of the nonlinear medium is minimised.

19. (canceled)

20. The apparatus of claim 1, wherein the apparatus is configured as a wavelength converter in a communications network, configured to convert one or more communications channel signal waves to idler waves at different frequencies for multiplexing into a communications medium to mitigate channel contention in the communications medium.

21. A method for configuring a phase adjusting means in an apparatus as claimed in any preceding claim to suppress unwanted idlers at an output of a nonlinear medium, comprising:
operating a single pump wave source or two non-degenerate pump wave sources to provide the or each pump wave to propagate along the optical path in the nonlinear medium;
operating one or more signal wave sources to provide the or each signal wave to propagate along the optical path in the nonlinear medium;
detecting, using a detector, the light beams at the output of the nonlinear medium and determining a signal representative of the detected power spectral density of the light beams;
determining a wavelength-dependent phase shift for wavelengths of light propagating in the nonlinear medium so as to suppress the detected power of the unwanted idler waves at the frequencies f_{i.u1}, f_{i.u2} . . . f_{i.un} at an output of the nonlinear medium.

22. The method of claim 21, wherein determining the wavelength-dependent phase shift comprises:
determining a wavelength-dependent phase shift such that dispersion in the nonlinear medium is compensated for at least in the range including the or each pump wave, the or each signal wave and the or each wanted idler waves.

23. The method of claim 22, wherein determining a wavelength-dependent phase shift such that dispersion in the nonlinear medium is compensated for comprises:
sweeping a wavelength of one of the signal wave sources in the range; and
determining, at wavelengths in the sweep, a wavelength-dependent phase shift for that swept wavelength to maximise the detected power of a wanted idler wave generated for the signal wave at that swept wavelength.

24. The method of claim 21, wherein determining the wavelength-dependent phase shift further comprises:
determining a wavelength-dependent phase shift for wavelengths of light for the or each pump wave such that the detected power of the unwanted idler waves at the frequencies f_{i.u1}, f_{i.u2} . . . f_{i.un} at an output of the nonlinear medium is minimised.

25. The method of claim 21, wherein determining the wavelength-dependent phase shift further comprises:
determining a wavelength-dependent phase shift for wavelengths of light propagating in the nonlinear medium so as to enhance the detected power of the wanted idler waves at the frequencies f_{i.w1}, f_{i.w2} . . . f_{i.wn} at an output of the nonlinear medium.

26. The method of claim 25, further comprising determining a wavelength-dependent phase shift for wavelengths of light propagating in the nonlinear medium so as to maximise the ratio of the detected power of the wanted idler waves to the detected power of the unwanted idler waves at the output of the nonlinear medium.

27. The method of claim 21, wherein determining the wavelength-dependent phase shift comprises:
providing, as the phase adjusting means, at least one programmable optical filter;
adjusting the applied phase shift at the or each programmable optical filter based on the detected power to determine the wavelength-dependent phase shift.

28. The method of claim 27, further comprises determining one or more phase masks for one or more fibre Bragg gratings to provide the determined wavelength-dependent phase shift in the optical path;
fabricating the or each fibre Bragg grating using the or each determined phase mask; and
providing the or each fabricated fibre Bragg grating at locations in the optical path in the nonlinear medium to provide the phase adjusting means.
